(19) United States
(12) Patent Application Publication
(10) Pub. No.: US 2020/0158068 A1
(43) Pub. Date: May 21, 2020

(54) START CONTROL DEVICE AND START CONTROL METHOD FOR ENGINE

(71) Applicant: ISUZU MOTORS LIMITED, Shinagawa-ku, Tokyo (JP)

(72) Inventor: Hiroshi IKUTAKE, Suginami-ku (JP)

(21) Appl. No.: 16/611,042

(22) PCT Filed: May 8, 2018
(86) PCT No.: PCT/JP2018/017700

§ 371 Date: Nov. 5, 2019

(30) Foreign Application Priority Data
May 8, 2017 (JP) 2017-092215

(51) Int. Cl. F02N 11/08

(52) U.S. Cl. CPC F02N 11/0811; F02N 2200/024; F02N 2200/023; F02N 11/0851

(57) ABSTRACT

The start control device is provided with: a determination unit 110 for determining, when an engine 10 is being started, whether or not the engine 10 is in a prescribed cold-start state; and a start control unit 120 for causing, when the determination unit 110 determines that the engine is in the cold-start state, fuel injection to the engine 10 to be suspended and the engine 10 to be cranked for a preset threshold time by transmitting a torque from a starter motor 63 to a crankshaft 16 while, and starting fuel injection to the engine 10 once the threshold time elapses after the cranking is started.

### TECHNICAL FIELD

The present disclosure relates to a start control device and a start control method for an engine.

### BACKGROUND ART

Generally, when an engine is started, fuel injection from an injector is started simultaneously with cranking by a starter. Therefore, when the engine is started in a state where viscosity of lubricating oil is high, for example, during a low temperature start, the engine is load-driven by combustion of fuel before sufficient lubricating oil is supplied to sliding elements of the engine, which results in damage or seizure of the sliding elements.

For example, PTL 1 discloses a technology in which only cranking by a starter is performed when an engine is started, and thereafter, fuel injection from an injector is started when a lubricating oil pressure reaches a predetermined pressure, thereby preventing damage of sliding elements.

### CITATION LIST

### Patent Literature

PTL 1: JP-A-2003-65085

### SUMMARY OF INVENTION

### Technical Problem

In the technology described in PTL 1, when the engine is started, the fuel injection is always suspended until the lubricating oil pressure reaches the predetermined pressure, regardless of whether an outside air temperature or a coolant water temperature is high or low. Therefore, particularly during a low temperature start which requires a time of increasing the lubricating oil pressure, a start of the engine is significantly delayed against an intention of a driver, which gives the driver an uncomfortable feeling.

In addition, depending on a road condition such as on an expressway or at a railroad crossing, the engine needs to be restarted early so as to start the vehicle quickly when the engine stalls. Since an increase in the lubricating oil pressure is required to start the engine even in such a situation in the technology described in PTL 1, quick start of the vehicle is hindered with a delay in starting the engine, for example, when a time is required to increase the lubricating oil pressure, which gives the driver an extremely uncomfortable feeling.

An object of the technology provided by the present disclosure is to reduce the uncomfortable feeling given to the driver while effectively preventing the sliding elements from being damaged clue to insufficient lubricating oil when the engine is started.

### Solution to Problem

A device according to the present disclosure is a start control device for an engine in which the engine includes a starter motor capable of transmitting a rotational force to a crankshaft, and in which the start control device includes: determination means that determines whether the engine is in a predetermined low temperature starting state when the engine is started; and start control means that causes, when the determination means determines that the engine is in the low temperature starting state, the engine to be cranked fur a preset threshold time by transmitting the rotational force from the starter motor to the crankshaft in a state where fuel injection to the engine is suspended, and starts the fuel injection to the engine when the threshold time elapses after the cranking is started.

Preferably, the determination means determines, when the engine is started, that the engine is in the low temperature starting state in a case where a coolant water temperature of the engine is equal to or lower than a predetermined low temperature threshold.

The threshold time is preferably set to a relatively short time.

A method according to, the present disclosure is a start control method for an engine in which the engine includes a starter motor capable of transmitting a rotational force to a crankshaft, and in which the start control method includes: determining whether the engine is in a predetermined low temperature starting state when the engine is started; causing, in response to a determination that the engine is in the low temperature starting state, the engine to be cranked for a preset threshold time by transmitting the rotational force from the starter motor to the crankshaft in a state where fuel injection to the engine is suspended; determining whether the threshold time elapses after the cranking is started: and starting the fuel injection to the engine in response to a determination that the threshold time elapses after the cranking is started.

### Advantageous Effects of Invention

According to the technique provided by the present disclosure, the uncomfortable feeling given to the driver can be reduced while the sliding elements can be effectively prevented from being damaged due to insufficient lubricating oil when the engine is started.

### BRIEF DESCRIPTION OF DRAWINGS

FIG. 1 is a schematic overall configuration diagram of an engine according to an embodiment of the present disclosure.

FIG. 2 is a flowchart showing start control processing of the engine according to the embodiment of the present disclosure.

### DESCRIPTION OF EMBODIMENTS

Hereinafter, a start control device and a starting control method according to an embodiment of the present disclosure will be described with reference to the accompanying drawings. The same components are denoted by the same reference numerals, and names and functions of these components are also the same. Therefore, detailed description thereof will not be repeated.

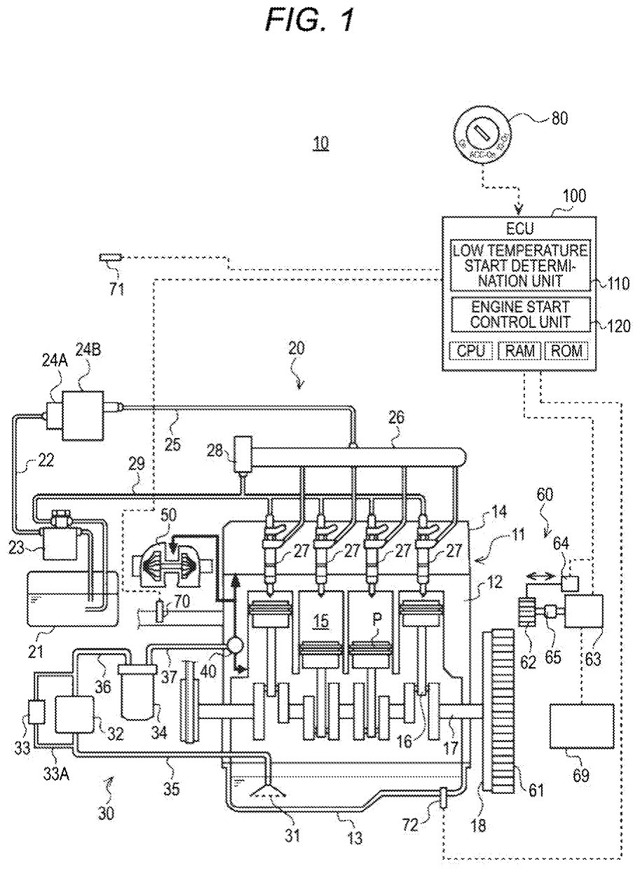

FIG. 1 is a schematic overall configuration diagram of a diesel engine (hereinafter simply referred to as an engine) 10 equipped with a start control device according to the present embodiment. The engine 10 includes an engine main body 11, a fuel injection device 20, a lubricating oil supply device 30, a starter unit 60 and an electronic control unit (ECU) 100. In the drawing, reference numeral 70 denotes a water temperature sensor that acquires an engine coolant water temperature, reference numeral 71 denotes an outside air temperature sensor that acquires an outside air temperature, reference numeral 72 denotes an oil temperature sensor that acquires a lubricating oil temperature, and reference numeral 80 denotes an ignition switch.

The engine main body 11 includes a cylinder block 12, an oil pan 13 provided at a lower portion of a crankcase of the cylinder block 12, and a cylinder head 14. The cylinder block 12 is provided with a cylinder bore 15. A piston P reciprocally accommodated in the cylinder bore 15. The piston P is connected to a crankshaft 17 via a connecting rod 16. That is, when the piston P reciprocates in the cylinder bore 15, the reciprocating motion is converted into a rotational motion by the connecting rod 16, and thus, the crankshaft 17 is rotated. Reference numeral 18 denotes a flywheel fixed to an output end of the crankshaft 17.

The fuel injection device 20 includes a fuel tank 21, a fuel suction pipe 22, a fuel filter 23, a feed pump 24A, a high-pressure pump 24B, a fuel supply pipe 25, a common rail 26, a plurality of injectors 27 that inject fuel into cylinders, a pressure control valve 28 and a return pipe 29.

The fuel tank 21 stores fuel (for example, light oil). One end side of the fuel suction pipe 22 is immersed in the fuel in the fuel tank 21, and another end side of the fuel suction pipe 22 is connected to a suction port of the feed pump 24A. The fuel filter 23 is interposed in the fuel suction pipe 22, and removes foreign matters in the fuel pumped up by the feed pump 24A.

The feed pump 24A and the high-pressure pump 24B are driven by power transmitted from the crankshaft 17 of the engine 10. The feed pump 24A supplies the fuel pumped up from the fuel tank 21 via the fuel suction pipe 22 to the high-pressure pump 24B. The high-pressure pump 24B includes a plunger that reciprocates by rotation of a shaft (not shown), and pressurizes and discharges the fuel by the reciprocating motion of the plunger. The high-pressure fuel pressurized by the high-pressure pump 24B is supplied to the common rail 26 via the fuel supply pipe 25.

The common rail 26 accumulates the high-pressure fuel supplied from the high-pressure pump 24B, and distributes the accumulated high-pressure fuel to each of the injectors 27. Fuel injection from each of the injectors 27 is controlled in response to a command from the ECU 100. The common rail 26 is provided with the pressure control valve 28, and when pressure in the common rail 26 reaches a predetermined value, the high-pressure fuel is returned to the fuel tank 21 via the return pipe 29.

The lubricating oil supply device 30 supplies lubricating oil stored in the oil pan 13 to sliding elements of the engine 10, and includes an oil strainer 31, an oil pump 32, a relief valve 33, an oil filter 34 and an oil gallery 40.

The oil strainer 31 is a filter that removes the foreign matters contained in the lubricating oil, and is immersed in the lubricating oil in the oil pan 13. The oil strainer 31 is connected to a suction port of the oil pump 32 via a lubricating oil suction pipe 35.

The oil pump 32 pumps the lubricating oil, and is driven by the power transmitted from the crankshaft 17 of the engine 10. A first lubricating oil supply pipe 36 is connected to a discharge port of the oil pump 32.

The relief valve 33 is interposed in a relief pipe 33A that connects the first lubricating oil supply pipe 36 and the lubricating oil suction pipe 35 and bypasses the oil pump 32. The relief valve 33 is opened during medium to high speed rotation of the engine 10 when a pumping amount of the oil pump 32 is increased to circulate the lubricating oil so as not to excessively increase oil pressure in the oil gallery 40.

The oil filter 34 removes the foreign matters contained in the lubricating oil pumped up from the oil pump 32, and a downstream end of the first lubricating oil supply pipe 36 is connected to an inlet port of the oil filter 34. A second lubricating oil supply pipe 37 is connected to an outlet port of the oil filter 34.

The oil gallery 40 is connected to a downstream end of the second lubricating oil supply pipe 37. The lubricating oil introduced into the oil gallery 40 is supplied to the sliding elements such as a valve mechanism, an oil jet, a journal portion of the crankshaft 17 and a rotation shaft of a turbocharger 50 (each of which is not shown), and is returned to the oil pan 11 after lubricating the sliding elements.

The starter unit 60 includes a ring gear 61 provided on the flywheel 18, a pinion gear 62 capable of meshing with the ring gear 61, and a starter motor 63 driven by electric power supplied from an in-vehicle battery 69 to rotate the pinion gear 62.

An output shaft of the starter motor 63 is connected to an input shaft of the pinion gear 62 via a one-way clutch 65. The one-way clutch 65 allows only power transmission from a starter motor 63 side to a pinion gear 62 side. The pinion gear 62 is movable in a shaft direction by a solenoid 64, and is selectively moved between a meshing position where the pinion gear 62 meshes with the ring gear 61 and a non-meshing position where the pinion gear 62 does not mesh with the ring gear 61.

Actuation of the starter motor 63 and the solenoid 64 is controlled in response to a command from the ECU 100. Specifically, when the ignition switch 80 is operated from OFF to ON by a driver, the solenoid 64 is actuated in response to a cranking command input from the ECU 100, and the pinion gear 62 is moved to the meshing position where the pinion gear 62 meshes with the ring gear 61. In addition, electric power is supplied from the in-vehicle battery 69 to the starter motor 63, and driving force of the starter motor 63 is transmitted from the ring gear 62 to the flywheel 18 to rotate the crankshaft 17, whereby the engine 10 is cranked.

The ECU 100 performs various controls of the engine 10 and the like, and includes a known CPU, a ROM, a RAM, an input port, an output port and the like. The ECU 100 includes a low temperature start determination unit 110 (an example of determination means) and an engine start control unit 120 (an example of a start control unit) as some functional elements. Although these functional elements are described as being included in the ECU 100 that is an integral hardware, any one of these may be provided in a separate hardware.

The low temperature start determination unit 110 determines, when the engine 10 is started by operating the ignition switch 80 from OFF to ON by the driver, whether the engine 10 is in a predetermined low temperature starting state. In the present embodiment, whether the engine 10 is in the low temperature starting state is determined based on a sensor value acquired by the water temperature sensor 70. Specifically, when a coolant water temperature input from the water temperature sensor 70 is equal to or lower than a predetermined low temperature threshold (for example, about 25 degrees) indicating that viscosity of the lubrication oil is high, the low temperature start determination unit 110 determines that the engine 10 is in the low temperature starting state. Whether the engine 10 is in the low temperature starting state may be determined based on an outside air temperature acquired by the outside air temperature sensor 71, a lubricating oil temperature acquired by the oil temperature sensor 72, and the like.

In a case where the low temperature start determination unit 110 determines, when the ignition switch 80 is turned ON by the driver, that the engine 10 is not in the low temperature starting state, the engine start control unit 120 outputs a cranking command to the starter unit 60 and simultaneously outputs an instruction signal for causing the injector 27 to start fuel injection.

On the other hand, in a case where the low temperature start determination unit 110 determines, when the ignition switch 80 is turned ON by the driver, that the engine 10 is in the low temperature starting state, the engine start control unit 120 causes the engine 10 to be cranked for a predetermined threshold time (for example, about 2 seconds) by outputting a cranking command to the starter unit 60 in a state where the fuel injection from the injector 27 is suspended, and outputs an instruction signal for causing the injector 27 to start fuel injection when the threshold time elapses after the cranking is started.

In this way, during a low temperature start when the viscosity of the lubricating oil is high, the fuel injection is suspended only cranking is performed until the threshold time elapses, whereby the lubricating oil is reliably supplied to the sliding elements of the engine 10 such as a bearing of the turbocharger 50 before rotation of the turbocharger 50 is increased due to load driving accompanying combustion of the engine 10. Thereby, the bearing or the like of the turbocharger 50 can he effectively prevented from being damaged or seized due to insufficient lubricating oil. By setting the threshold time for suspending the fuel injection to a relatively short time (about 2 seconds), a significant delay in starting the engine 10 is prevented, and an uncomfortable feeling of the driver can be effectively reduced.

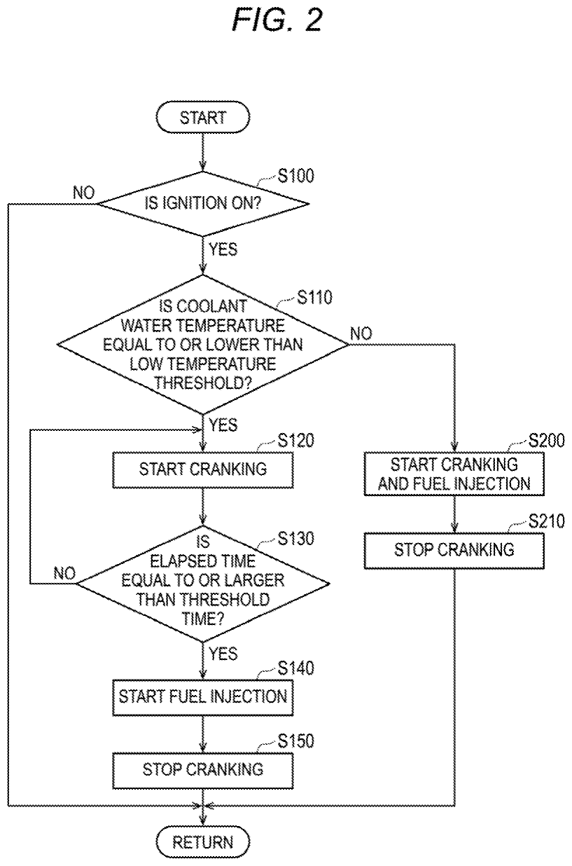

Next, start control processing of the engine 10 according to the present embodiment will be described with reference to a flowchart, in FIG. 2.

In step S100, whether the ignition switch 80 is turned ON by the driver is determined. In a case where the ignition switch 80 is turned ON (YES), the control proceeds to step S110.

In step S110, whether the engine 10 is in the low temperature starting state is determined based on the sensor value acquired by the water temperature sensor 70. Specifically, when the engine 10 is in the low temperature starting state where the coolant water temperature is equal to or lower than the predetermined low temperature threshold (for example, about 25 degrees) (YES), the control proceeds to step S120. On the other hand, when the engine 10 is not in the low temperature starting state (NO), the control proceeds to step S200, where the fuel injection is started simultaneously with the cranking, and the normal start control for stopping the cranking is performed in step S210.

In step S120, the starter motor 63 of the starter unit 60 and the solenoid 64 are actuated to start the cranking of the engine 10 in the state where the fuel injection from the injector 27 is suspended.

In step S130, whether the elapsed time after the cranking is started has reached the predetermined threshold time (for example, about 2 seconds) is determined. When the determination is YES, the control proceeds to step S140 and the fuel injection from the injector 27 is started. In step S150, the actuation of the starter unit 60 is stopped.

As described above in detail, according to the present embodiment, during the low temperature start when the viscosity of the lubricating oil is high, the fuel injection is suspended and only the cranking is performed until the threshold time elapses, whereby the lubricating oil is reliably supplied to the sliding elements of the engine 10 such as the bearing of the turbocharger 50 before the rotation of the turbocharger 50 is increased by the load driving of the engine 10. Thereby, the bearing or the like of the turbocharger 50 can be effectively prevented from being damaged or seized due to insufficient lubricating oil during the low temperature start. By setting the threshold time for suspending the fuel injection to a relatively short time, the uncomfortable feeling of the driver due to a significant delay in starting the engine 10 can be effectively reduced.

The present invention is not limited to the above embodiment, and can be appropriately modified and implemented without departing from the spirit of the present invention.

For example, the start control is applied during the start when the ignition switch 80 is turned ON by the driver. However, in a case where the engine 10 has an idle stop function, the engine 10 may be applied during restart when an idle stop is released (for example, an accelerator operation is performed).

In addition, the engine 10 is not limited to a diesel engine, and other engines such as a gasoline engine can be widely applied.

The present application is based on Japanese Patent Application No. 2017-092215 filed on May 8, 2017, contents of which are incorporated herein as reference.

### INDUSTRIAL APPLICABILITY

The present disclosure has an effect of reducing an uncomfortable feeling of a driver while effectively preventing sliding elements from being damaged due to insufficient lubricating oil when engine is started, and is useful in that a vehicle that can provide a comfortable engine start feeling while extending a life of the engine is realized.

### REFERENCE SIGNS LIST

10 engine

11 engine main body portion

17 crankshaft

18 flywheel

20 fuel injection device

27 injector

30 lubricating oil supply device

32 oil pump

50 turbocharger

60 starter unit

61 ring gear

62 pinion gear

63 starter motor

70 water temperature sensor

80 ignition switch

100 ECU

110 low temperature start determination unit

120 engine start control unit

1. A start control device for an engine, the engine including a starter motor capable of transmitting a rotational force to a crankshaft, the start control device comprising:
determination means that determines whether the engine is in a predetermined low temperature starting state when the engine is started; and
start control means that causes, when the determination means determines that the engine is in the low temperature starting state, the engine to be cranked for a preset threshold time by transmitting the rotational force from the starter motor to the crankshaft in a state where fuel injection to the engine is suspended, and starts the fuel injection to the engine when the threshold time elapses after the cranking is started.

2. The start control device for the engine according to claim 1,
wherein the determination means determines, when the engine is started, that the engine is in the low temperature starting state in a case where a coolant water temperature of the engine is equal to or lower than a predetermined low temperature threshold.

3. The start control device for the engine according to claim 1,
wherein the threshold time is set to a relatively short time.

4. A start control method for an engine, the engine including a starter motor capable of transmitting a rotational force to a crankshaft, the start control method comprising:
determining whether the engine is in a predetermined low temperature starting state when the engine is started;
causing, in response to a determination that the engine is in the low temperature starting state, the engine to be cranked for a preset threshold time by transmitting the rotational force from the starter motor to the crankshaft in a state where fuel injection to the engine is suspended;
determining whether the threshold time elapses after the cranking is stared; and
starting the fuel injection to the engine in response to a determination that the threshold time elapses after the cranking is started.
